(19) United States
(12) Patent Application Publication
(10) Pub. No.: US 2012/0316893 A1
(43) Pub. Date: Dec. 13, 2012

(54) HEALTH INSURANCE CARD VERIFICATION SYSTEM AND HEALTH INSURANCE CARD VERIFICATION METHOD

(75) Inventor: Hiroshi Egawa, Meguro-ku (JP)

(73) Assignee: Planning of Healthcare & Environmental Wellbeing Corp., Tokyo (JP)

(21) Appl. No.: 13/518,512

(22) PCT Filed: Dec. 8, 2010
(86) PCT No.: PCT/JP2010/072015

§ 371 Date: Aug. 23, 2012

(30) Foreign Application Priority Data
Dec. 25, 2009 (JP) 2009295271

(51) Int. Cl. G06Q 50/22; G06Q 40/08

(52) U.S. Cl. 705/2

(57) ABSTRACT

For a revisit patient, a first terminal reads a patient identification card. The first terminal reads a health insurance card if it is required, and compares health insurance card data with reference data. If there is a difference, the first terminal prompts the user to go to a window for verification of the health insurance card. A second terminal displays a different part of the health insurance card data that is different from the reference data, and receives an input of data corresponding to the different part. The data input via the second terminal is registered in health insurance card database. A third terminal obtains a patient list and displays the list so that the patient is visually different from another patient.

### TECHNICAL FIELD

The present invention relates to a system and a method for verifying a health insurance card.

### BACKGROUND

In countries that have a healthcare insurance system (medical insurance system), individual certification such as a “health insurance card” is provided to certify that a person is insured. A medical institution has to periodically check the health insurance card of a patient to verify that the patient is still insured.

In some cases, if a patient's health insurance card is not certified, the patient cannot receive a medical service. Since a procedure for checking a health insurance card takes time, problems may arise in relation to an order of provision of medical services. For example, if the two patients report consecutively to a reception at a medical facility, and a second patient completes the certification of the health insurance card and receives a medical service before a first patient, the first patient may be dissatisfied. To prevent such a problem, JP-A-8-101869, published on Apr. 16, 1996, discloses a system in which numbered tickets are issued in an order of reporting to the reception.

JP-A-2007-48146, published on Feb. 22, 2007, discloses a technology for scanning ad registering a certified health insurance card. Further, JP-A-2007-48146 discloses a technology for referring to the recorded health insurance card registration information, for future verification.

### SUMMARY

If automatic reference to health insurance card registration information for a revisiting patient is available, a workload of the staff of a medical facility can be reduced. However, if a health insurance card cannot be verified automatically, it has to be verified manually. In such a case, the patient reports to a specified window in a medical facility, and submits his/her health insurance card. Thereafter, time is required to verify the health insurance card. If the patient waits in line to receive a medical service after verification of the health insurance card, the patient may be examined later than another patient who reported to reception later but completed the verification process prior to the patient. As a result, the patient has to wait longer to receive a medical service.

The present invention provides a technique for quick verification of a health insurance card and for smooth transfer from the health insurance card verification process to receiving a medical service.

According to one aspect of the invention, there is provided a health insurance card verification system, including: a first database; a second database; a first terminal that communicates with each of the first database and the second database; a second terminal that communicates with each of the first database and the second database; and a third terminal that communicates with each of the first database and the second database, wherein the first terminal includes: an ID obtaining unit configured to obtain a patient ID identifying a patient from a patient identification card; an examination order obtaining unit configured to obtain an examination order corresponding to the patient ID obtained by the ID obtaining unit, from the first database; a registration unit configured to register the examination order obtained by the examination order obtaining unit and the patient ID obtained by the ID obtaining unit; a health insurance card data obtaining unit configured to obtain health insurance card data from a health insurance card of the patient; and a notification unit configured to notify that verification of the health insurance card is required, in a case that the health insurance card data obtained by the health insurance card data obtaining unit does not match reference data recorded in the second database, the second terminal includes: an ID obtaining unit configured to obtain a patient ID identifying a patient from a patient identification card; a display unit configured to display a different part of the health insurance card data relating to the patient ID obtained by the ID obtaining unit that is different from the health insurance card data in the second database as well as the examination order stored along with the patient ID in the first database; a receiving unit configured to receive an input of data corresponding to the different part; and an updating unit configured to update the second database by replacing a part of the reference data corresponding to the different part relating to the patient ID with the data received by the receiving unit, and the third terminal includes: a display unit configured to display a patient list including patient data obtained from the first database, in accordance with the examination order; an ID obtaining unit configured to obtain the patient ID from the patient identification card; and a control unit configured to control the display unit to display the patient list in which the patient ID obtained by the ID obtaining unit is visually different from another patient ID.

According to another aspect of the invention, there is provided a method for verifying a health insurance card in a system including a first terminal, a second terminal, and a third terminal, that can communicate with a first database and a second database, the method including: obtaining, by the first terminal, a patient ID identifying a patient from a patient identification card; obtaining, by the first terminal, an examination order corresponding to the obtained patient ID, from the first database; registering, by the first terminal, the obtained examination order and the obtained patient ID; obtaining, by the first terminal, health insurance card data from a health insurance card of the patient; notifying, by the first terminal, that verification of the health insurance card is required, in a case that the obtained health insurance card data does not match reference data recorded in the second database; obtaining, by the second terminal, a patient ID identifying a patient from a patient identification card; displaying, by the second terminal, a different part of the health insurance card data relating to the obtained patient ID that is different from the health insurance card data in the second database as well as the examination order stored along with the patient ID in the first database; receiving, by the second terminal, an input of data corresponding to the different part; updating, by the second terminal, the second database by replacing a part of the reference data corresponding to the different part relating to the patient ID with the received data; displaying, by the third terminal, a patient list including patient data obtained from the first database, in accordance with the examination order; obtaining, by the third terminal, the patient ID from the patient identification card; and controlling, by the third terminal, the display unit to display the patient list in which the patient ID obtained by the ID obtaining unit is visually different from another patient ID.

According to the invention, for example, in a case that the first terminal is installed in a hospital as a reception device for a revisiting patient, and the second terminal is installed in a window for verifying the health insurance card, the different part from the reference data is displayed in the second terminal. Therefore, a staff member of the hospital can easily confirm the difference. The third terminal is installed, for example, at a reception of a department. Since an identification card of a patient is read by the third terminal, the third terminal can provide a patient list including patients who has arrives at the department. If a patient is called to receive a medical service before a second patient who has earlier examination order arrives at the department, the second patient can be called prior to another patient. Therefore, the second patient can receive a medical service without waiting too long time.

The control unit in the third terminal may control display of the patient list so that the patient ID updated at the second terminal is visually different from non-updated patient ID. Since a patient who has completed the health insurance card verification process is shown in visually different way, a doctor or a medical staff member can easily confirm that the patient has completed the health insurance card verification process or not.

The health insurance card verification system may further include a fourth terminal including: a first reading unit configured to read patient information relating to a patient from a written application; a second reading unit configured to read health insurance card data from a health insurance card of the patient; an obtaining unit configured to obtain a patient ID of the patient from a third database including patient data for each patient ID; a registering unit configured to register the health insurance card data into the second database and the patient data corresponding to the patient ID into the third database if contents of items common to the patient information read by the first reading unit and the health insurance card data are coincident. The system reduces workload for comparing a written application and a health insurance card of the patient or inputting data relating the written application.

The health insurance card verification system may further include a processing device including: a receiving unit configured to receive patient information including identification of a patient and the health insurance card data of the patient from another device; a registering unit configured to register a data set in the second database, the data set including the patient ID, the patient information, and the health insurance card data, the patient ID being obtained from the first database. The system may reduce workload for receiving an introduced patient since information relating to the health insurance card input by another hospital can be used.

### BRIEF DESCRIPTION OF THE DRAWINGS

FIG. 1 shows an example of a network configuration of a health insurance card verification system in accordance with an exemplary embodiment.

FIG. 2 shows a configuration of server device 10.

FIG. 3 shows a configuration of terminal 20.

FIG. 4 shows a configuration of terminal 30.

FIG. 5 shows a configuration of terminal 40.

FIG. 6 shows a configuration of terminal 50a in department A.

FIG. 7 shows functional configuration relating to the health insurance card verification process by terminal 30, terminal 40, and terminal 50.

FIG. 8A shows an example of patient database 100a.

FIG. 8B shows an example of health insurance card database 100b.

FIG. 9A shows an example of unverified card database 100c.

FIG. 9B shows an example of examination order management database 100d.

FIG. 10 shows a flowchart illustrating the reception process for a new patient.

FIG. 11A shows a flowchart illustrating the reception process for a revisiting patient.

FIG. 11B shows a flowchart illustrating the reception process for a revisiting patient.

FIG. 12A shows an example of an image relating to the reception process for a revisiting patient.

FIG. 12B shows an example of an image relating to the reception process for a revisiting patient.

FIG. 12C shows an example of an image relating to the reception process for a revisiting patient.

FIG. 12D shows an example of an image relating to the reception process for a revisiting patient.

FIG. 12E shows an example of an image relating to the reception process for a revisiting patient.

FIG. 13 shows a flowchart illustrating the health insurance card verification process.

FIG. 14 shows an example of an image relating to verification of the health insurance card.

FIG. 15 shows a flowchart illustrating displaying the patient list.

FIG. 16A shows an example of the patient list.

FIG. 16B shows an example of the patient list.

FIG. 17 shows a flowchart illustrating display control in terminal 50.

FIG. 18 shows an example of a configuration of health insurance card verification system according to modification 10.

### BRIEF DESCRIPTION OF THE REFERENCE NUMERALS

1 . . . health insurance card verification system; 10 . . . server device; 20, 30, 40, 50, 50a, and 50b . . . terminal; 60 . . . communication device; 101, 201, 301, 401, and 501 . . . control unit; 102 . . . storage unit; 103. 207, 306, 405, and 504 . . . communication unit; 202, 302, 304, and 402 . . . reading unit; 205 . . . patient identification card issue unit; 206 and 305 . . . reception sheet issue unit; 203, 404, and 503 . . . input unit; 204, 303, 403, and 502 . . . display unit; 500 . . . reading unit

### DETAILED DESCRIPTION

### 1. Outline

In the present exemplary embodiment, a patient reports to general reception to request a medical service in a desired department. If necessary, a health insurance card of the patient is verified. After reporting to the general reception, the patient reports to a reception in the desired department and waits his/her turn.

A health insurance card verification system in accordance with the present exemplary embodiment provides quick verification of the health insurance card at a general reception. Further, the health insurance card verification system provides unimpeded provision of a medical service in the desired department. It is noted that an example is described here in detail assuming a hospital having departments A and B, however, this is merely an example and is not intended to limit a type of hospital or a number of departments.

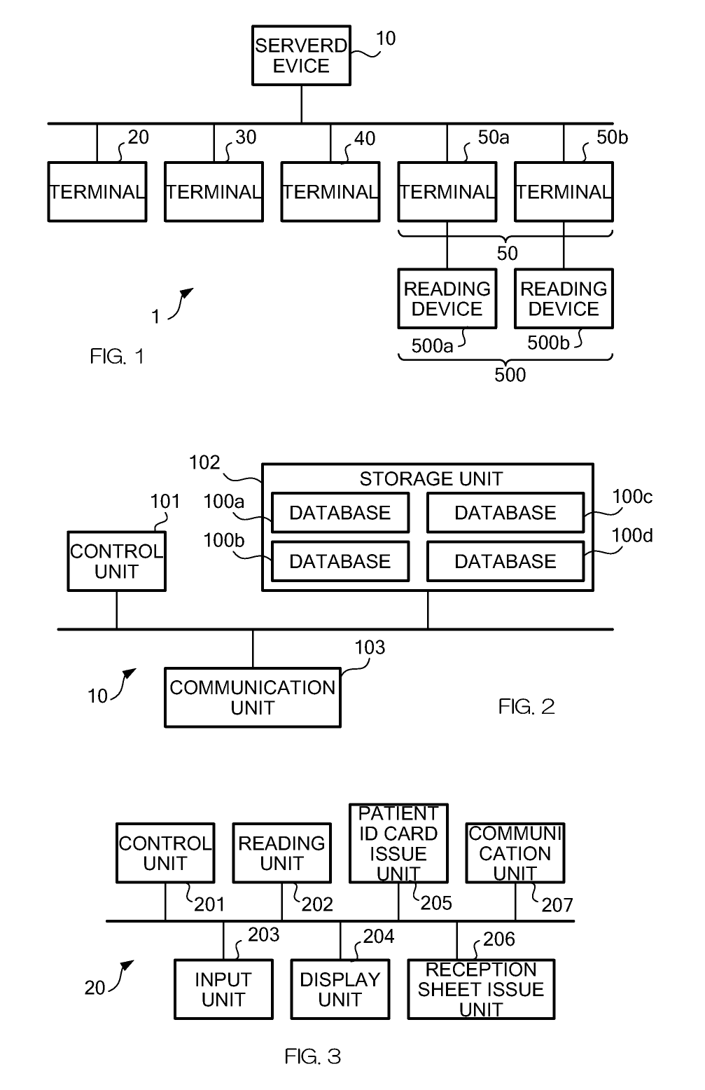

FIG. 1 shows an example of a network configuration of a health insurance card verification system in accordance with an exemplary embodiment. Health insurance card verification system 1 includes server device 10 (an example of a processing device), terminal 20 (an example of a fourth terminal), terminal 30 (an example of a first terminal), terminal 40 (an example of a second terminal), and terminal 50 (50a, 50b) (an example of a third terminal). Terminal 20 is a terminal for reception of a patient who visits the hospital for the first time. Terminal 30 is a terminal for reception of a patient who has visited the hospital previously. Terminal 40 is a terminal operated by a member of the hospital staff to verify the health insurance card. Terminal 50 is placed in each examination room, and is operated by a doctor of the department.

As shown in FIG. 1, in health insurance card verification system 1, server device 10 and each terminal are connected by a network cable. Terminal 20, terminal 30, and terminal 40 are placed at the general reception. At a reception of each department, readers 500 (500a, 500b) are provided, and connected to terminals 50, respectively.

Here, a flow of a process of reception of a patient and provision of a medical service in a hospital where health insurance card verification system 1 is used will be described.

(1) A patient visiting a hospital for the first time submits a written application and his/her health insurance card to a reception for new patients. The patient completes a written application form, which includes personal information (name and date of birth, for example) and a desired department. A staff member at the reception for new patients receives the written application and the health insurance card, and operates terminal 20 to complete the check in process. The staff member issues a patient identification card and a reception sheet on which an order in which patients in the department are to be examined is described. The patient receives the patient identification card and the reception sheet from the staff member, and reports to the reception of the department.

(2) A revisiting patient, i.e., one who has visited the hospital previously, operates terminal 30 to input the desired department and verify the health insurance card. When a process at terminal 30 is completed, terminal 30 issues the reception sheet. The patient receives the reception sheet and goes to the reception of the department. It is noted that a patient whose health insurance card cannot be certified by terminal 30 (hereinafter referred to as a “specific patient”), is required to report to a window (hereinafter referred to as a “health insurance card verification window”) for verifying the health insurance card. A staff member at the window manually verifies the health insurance card.

(3) At the health insurance card verification window, the specific patient submits his/her patient identification card to the staff member. The staff member operates terminal 40 to certify the health insurance card of the specific patient. Once the health insurance card is certified, the specific patient reports to the reception of the department.

(4) A patient who completes the check in process at the reception or the verification of the health insurance card at the health insurance card verification window, operates reader 500 positioned at the reception of the department to read the patient identification card.

As summarized above, each terminal other than terminal 30 is operated by a staff member at the hospital, and terminal 30 is operated by the patient. Details of health insurance card verification system 1 will now be described with reference to the figures.

### 2. Configuration

### 2-1. Server Device 10

FIG. 2 shows a configuration of server device 10. Server device 10 includes control unit 101, storage unit 102, and communication unit 103. Control unit 101 includes a CPU (Central Processing Unit) and a memory (for example, a RAM (Random Access Memory) and a ROM (Read Only Memory). The CPU executes a control program stored in the ROM or storage unit 102, whereby control unit 101 controls each unit so as to execute a process.

Storage unit 102 includes a storage device such as a hard disk drive. Storage unit 102 stores patient database 100a, health insurance card database 100b, unverified card database 100c, examination order management database 100d, and medical records for each patient (not shown in the figures). Details of patient database 100a, health insurance card database 100b, unverified card database 100c, and examination order management database 100d will be described later. Communication unit 103 establishes a communication connection to each terminal, under the control of control unit 101, to perform data communication, using a pre-assigned address.

### 2-2. Terminal 20

FIG. 3 shows a configuration of terminal 20. Terminal 20 includes control unit 201, read unit 202, input unit 203, display unit 204, patient identification card issue unit 205, reception sheet issue unit 206, and communication unit 207. Control unit 201 includes a CPU and a memory (for example, a RAM and ROM). The CPU executes a control program stored in the ROM, whereby control unit 201 controls each unit so as to execute a process.

Read unit 202 includes an image scanner device. Read unit 202 further includes an OCR (Optical Character Reader) function to generate text data from the scanned image of the health insurance card. More specifically, read unit 202 sequentially scans the health insurance card at predetermined scanning positions. Read unit 202 checks the scanned image with predetermined reference images corresponding to plural types of health insurance card. Read unit 202 identifies a type of health insurance card based on the check results. Further, read unit 202 identifies an image area in which information relating to the insured person is described, in response to the identified type of health insurance card. The information shown in the image area is to be converted into text. Read unit 202 converts image data of the identified image area into text data. Read unit 202 outputs health insurance card text data and health insurance card data to control unit 201. The health insurance card text data includes the converted text data and information corresponding to the text data. The health insurance card data includes the scanned health insurance card image data.

Input unit 203 includes an input device such as a keyboard or a mouse. Input unit 203 receives an operation by a staff member, and outputs a signal to control unit 201 in response to the received operation. Display unit 204 includes a display device such as a liquid crystal display. Display unit 204 displays an image showing a menu for reception, under the control of control unit 201.

Patient identification card issue unit 205 issues a patient identification card, under the control of control unit 201. On the patient identification card, a patient ID and name of the patient are printed. In this example, the patient identification card is a magnetic card including a magnetic storage medium storing the patient ID and the name of the patient as the patient identification card data. Reception sheet issue unit 206 issues a reception sheet under the control of control unit 201. On the reception sheet, a patient ID, name of the patient, an identification of the department, and an examination order are printed in a predetermined area. The examination order shows an order in which examination takes place in the department in which the patient wishes to receive a medical service. Communication unit 207 establishes a communication connection with server device 10 to perform data communication, under the control of control unit 201, using a pre-assigned address.

### 2-3. Terminal 30

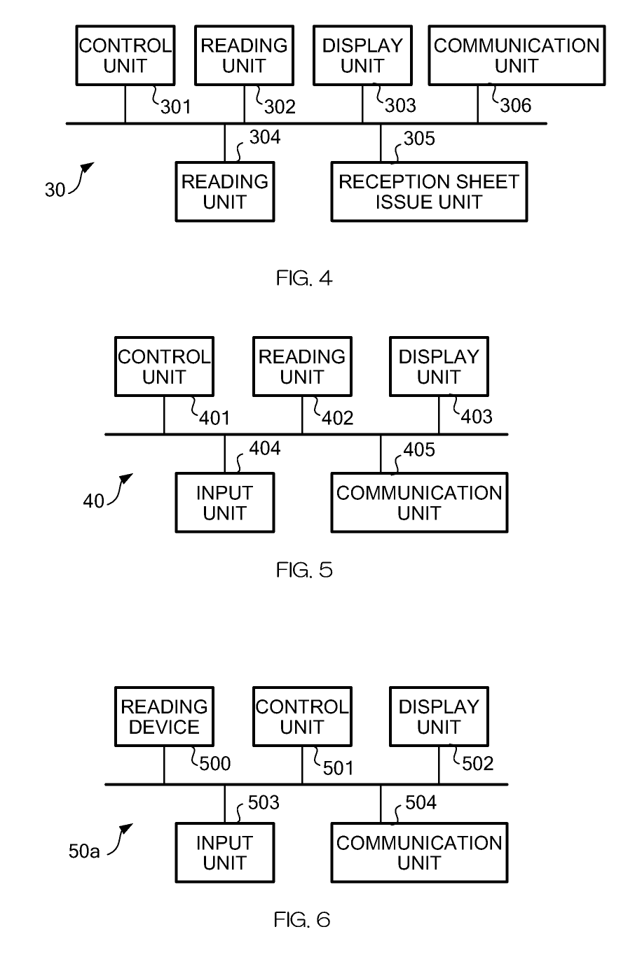

FIG. 4 shows a configuration of terminal 30. Terminal 30 includes control unit 301, read unit 302, display unit 303, read unit 304, reception sheet issue unit 305, and communication unit 306.

Control unit 301 includes a CPU and a memory (for example, a RAM and a ROM). By the CPU executing a control program stored in the ROM, control unit 301 controls each unit so as to execute a process for reception of a revisiting patient.

Read unit 302 includes a magnetic card reader device. Read unit 302 reads the patient identification card data including the patient ID and the name of the patient from the patient identification card. Read unit 302 outputs the read patient identification card data to control unit 301.

Display unit 303 includes a display device and a touch screen. Display unit 303 displays an image showing a menu for reception or a guide showing a patient how to operate the device. Display unit 303 outputs a signal in response to a location on the touch screen touched by a patient. The image showing a guide includes, for example, an image for prompting a patient who is required to verify the health insurance card, to submit the health insurance card, and an image for prompting a patient to go to the health insurance card verification window so as to certify the health insurance card. Read unit 304 has a function similar to the function of read unit 202 of terminal 20. Read unit 304 outputs health insurance card data to control unit 301. The health insurance card data includes the health insurance card image data and the health insurance card text data of the read health insurance card.

Reception sheet issue unit 305 issues a reception sheet on which a patient ID of a revisited patient, name of the patient, an identification of the department, and an examination order are printed in a predetermined area, under the control of control unit 301. In this example, to prevent provision of a medical service to a specific patient without certifying the health insurance card at the health insurance card verification window, the examination order is not printed on the reception sheet for the specific patient, while the examination order is printed on the reception sheet for other patients.

Communication unit 306 performs data communication, under the control of control unit 301, using a pre-assigned address, similarly to communication unit 207 of terminal 20.

### 2-4. Terminal 40

FIG. 5 shows a configuration of terminal 40. Terminal 40 includes control unit 401, read unit 402, display unit 403, input unit 404, and communication unit 405.

Control unit 401 includes a CPU and a memory (for example, a RAM and a ROM). By the CPU executing a control program stored in the ROM, control unit 401 controls each unit so as to execute a process for certifying the health insurance card.

Read unit 402 includes a magnetic card reader device to read unit 302 similarly to terminal 30. Read unit 402 reads the patient identification card data of the patient identification card, and outputs the patient identification card data to control unit 401. Display unit 403 includes a display device such as a liquid crystal display, for example. Display unit 403 displays an image showing a menu for verification of the health insurance card or an image showing a process for verifying the health insurance card.

Input unit 404 includes an input device such as a keyboard or a mouse. Input unit 404 receives an operation by a staff member and outputs to control unit 401a signal in response to the received operation. Communication unit 405 performs data communication with server device 10, under the control of control unit 401, using a pre-assigned address, similarly to communication unit 207 of terminal 20.

### 2-5. Terminal 50

FIG. 6 shows a configuration of terminal 50a in department A. Since terminal 50a and terminal 50b have the same configuration, description will be given for terminal 50a only. Terminal 50a includes a main console and reader 500. Reader 500 includes control unit 501, display unit 502, input unit 503, and communication unit 504.

Reader 500 is a magnetic card reader device that is located at the reception of department A. Reader 500 is connected to the main console by wired or wireless communication. Reader 500 reads the patient identification card of a patient and outputs the patient identification card data to control unit 501.

Control unit 501 includes a CPU and a memory (for example, a RAM and a ROM). By the CPU executing a control program stored in the ROM, control unit 501 controls each unit so as to execute a process for displaying a patient list.

Display unit 502 includes a display device such as a liquid crystal display. Display unit 502 displays an image showing a patient list, under the control of control unit 501. Input unit 503 includes an input device such as a keyboard or a mouse. Input unit 503 receives an operation by a doctor, and outputs a signal to control unit 501 in response to the received operation. Communication unit 504 performs data communication with server device 10, under the control of control unit 501, using a pre-assigned address, similarly to communication unit 207 of terminal 20.

### 3. Function to Verify a Health Insurance Card

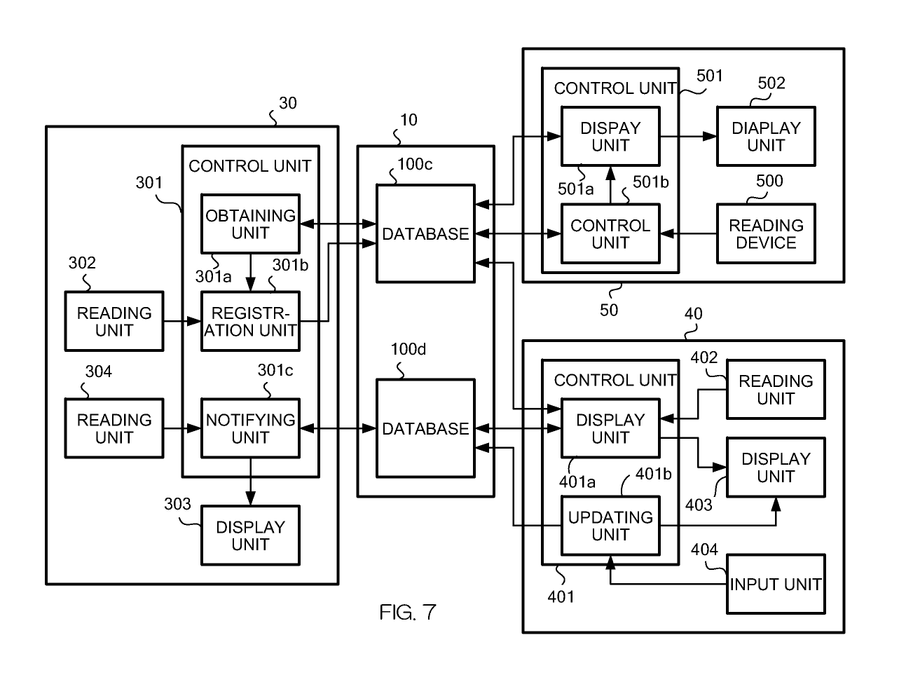

FIG. 7 shows functional configuration relating to the health insurance card verification process by terminal 30, terminal 40, and terminal 50. Control unit 301 of terminal 30 includes obtaining unit 301a, registering unit 301b, and notifying unit 301c. Obtaining unit 301a obtains an examination order from examination order management database 100d (an example of the first database) stored in server device 10. Registering unit 301b registers the patient ID read from the patient identification card by read unit 302 (an example of the identification reading unit) and the examination order obtained by obtaining unit 301a, to examination order management database 100d. If the health insurance card data read by read unit 304 (an example of the reading unit) is not coincident with the reference data registered in insurance card database 100b (an example of the second database), notifying unit 301c notifies a user that certification of the health insurance card is required, via display unit 303.

Control unit 401 of terminal 40 includes display control unit 401a and updating unit 401b. Display control unit 401a obtains the examination order corresponding to the patient ID read from the patient identification card by read unit 402 (an example of the identification reading unit), from examination order management database 100d (an example of the first database). Display control unit 401a obtains an examination order and a part which is different between the read health insurance card data and the reference data, from health insurance card database 100d, and controls display unit 403 to display the obtained data. Updating unit 401b updates health insurance card database 100b so that the different part is replaced by data input via input unit 404 (an example of the input unit).

Control unit 501 of terminal 50 includes display control unit 501a and control unit 501b. Display control unit 501a obtains a patient list from examination order management database 100d stored in server device 10. Display control unit 501a controls display unit 502 to display the patients included in the patient list, in the examination order. Control unit 501b controls display unit 502 to display the patient ID read by reader 500 (an example of the identification reading unit) so that the patient ID is visually different from those of other patients.

### 4. Data

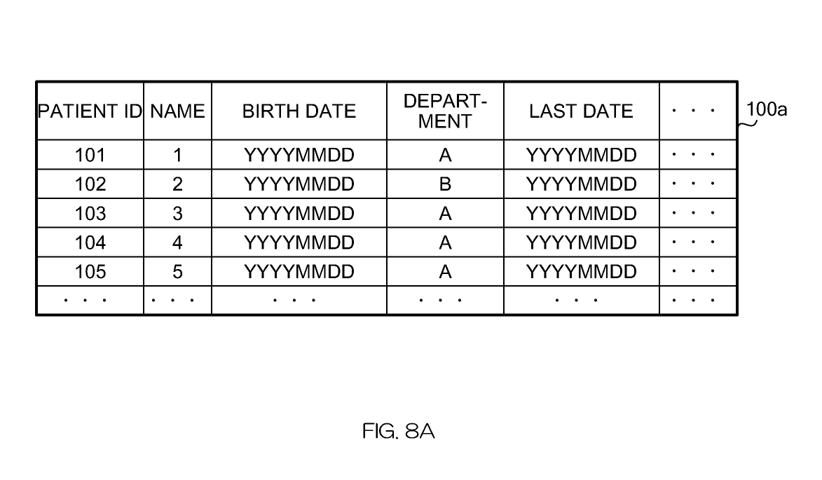

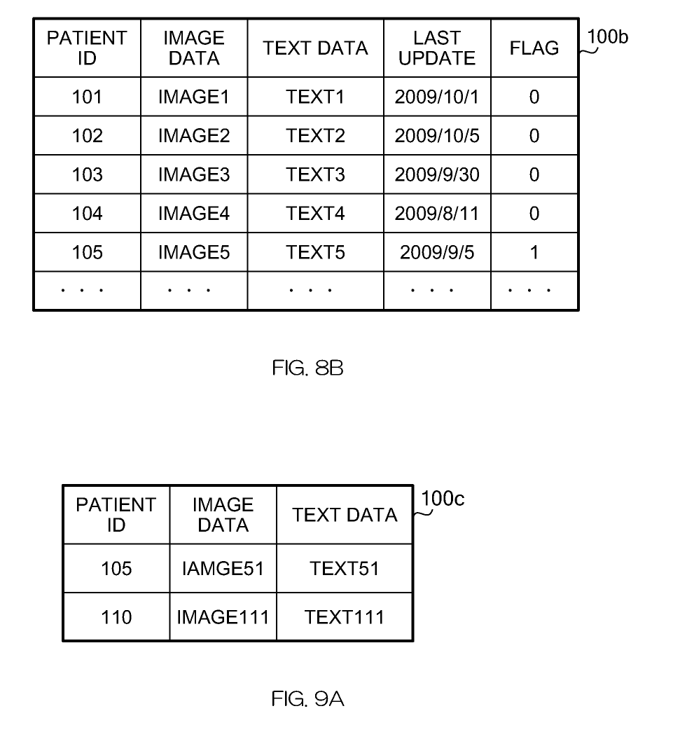

FIG. 8A shows an example of patient database 100a. Patient database 100a includes patient ID, the name of the patient, birth date of the patient, identification of the department, and the last date when the patient received a medical service. Patient ID is an identification of a patient. The identification of the department shows a department to which the patient is registered at the reception. The last date shows the date when the patient received the medical service at the hospital. The records for each patient ID in patient database 100a are generated when the patient reports to the reception for the first time. The identification of the department is updated every time the patient reports to the reception.

FIG. 8B shows an example of health insurance card database 100b. Health insurance card database 100b includes plural data sets. Each data set corresponds to a patient. Each data set includes a patient ID, health insurance card data (health insurance card image data and health insurance card text data), last verification date, and verification results. The last verification date shows the date when the health insurance card was most recently verified. The verification results show results of verification of the health insurance card.

When the reception process for a new patient is completed, the health insurance card image data and the health insurance card text data that are read during the reception process for a new patient are registered in health insurance card database 100b. The health insurance card text data includes text showing labels and contents. The labels include, for example, name, insurer's number, and insured person's number. The health insurance card text data is used as the reference data during the health insurance card verification process at terminal 30. The health insurance card image data and the health insurance card text data are updated in response to results of the verification process of the health insurance card at terminal 40.

The last verification date shows the date when the health insurance card was most recently verified. In other words, the last verification date is the date when the health insurance card was verified at terminal 20, terminal 30, or terminal 40.

The verification results include a flag showing a result of the health insurance card verification process at terminal 30. In this example, if the health insurance card data is coincident with the reference data, the flag is “0” while if the health insurance card data is not coincident with the reference data, the flag is “1.” The flag is updated for every health insurance card verification process, in response to the verification results.

In the present embodiment, for each patient, only the latest health insurance card data (that is obtained from the verified health insurance card) is registered in health insurance card database 100b. Alternatively, for each patient, plural health insurance card data may be registered along with the date of verification.

Next, a description will be given for unverified card database 100c, in which data is registered when the health insurance card is not verified during the verification process in terminal 30, and examination order management database 100d, in which examination orders that are given by terminal 20 and terminal 30 are registered.

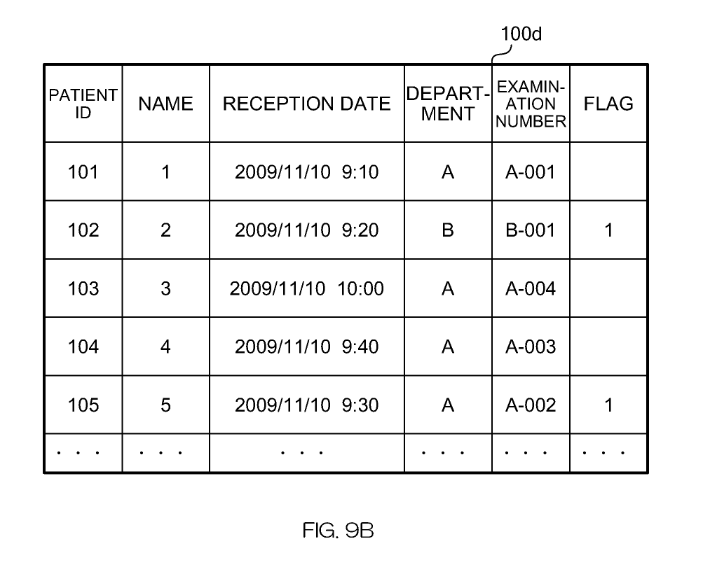

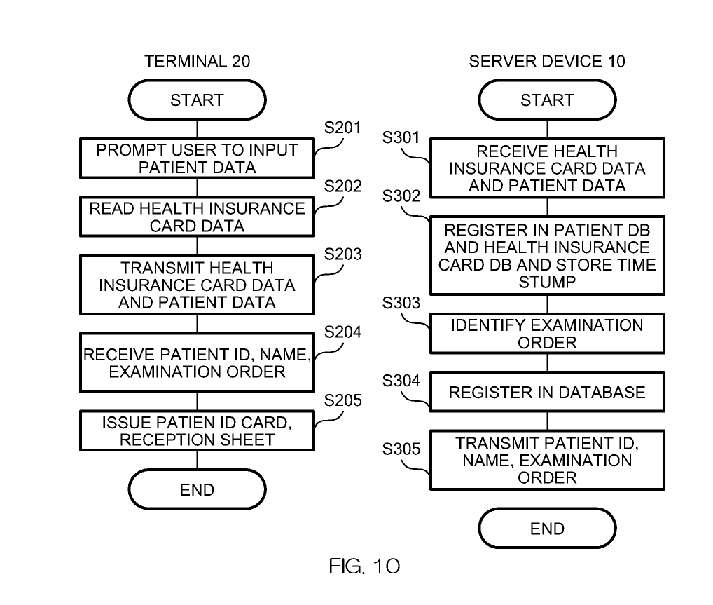

FIG. 9A shows an example of unverified card database 100c. Unverified card database 100c includes data sets, each of which is a data set of a patient whose health insurance card is not verified. The data set includes a patient ID, health insurance card data (health insurance card text data and health insurance card image data). The health insurance card data includes health insurance card image data and health insurance card text data that is not coincident with health insurance card text data (reference data) in health insurance card database 100b. In this example, the health insurance card text data includes difference information showing differences from reference data. Difference information includes, for example, an index at which the item is different from the reference data.

Health insurance card data in unverified card database 100c is read during the health insurance card verification process. Further, health insurance card data in unverified card database 100c is updated during the health insurance card verification process. The health insurance card data in health insurance card database 100b is replaced with the health insurance card text data and the health insurance card image data that are updated during the health insurance card verification process. Further, the updated health insurance card data are deleted from unverified card database 100c. In other words, each of the data sets in unverified card database 100c is deleted when the data set becomes coincident with the reference data.

FIG. 9B shows an example of examination order management database 100d. Examination order management database 100d includes a patient ID, name of the patient, date of reception, an identification of department, an examination order, and a complete flag. The date of reception indicates the date on which a patient checked in to the reception via terminal 20 or terminal 30. The identification of the department indicates a department that is input during the reception process. The complete flag indicates that the verification process for the health insurance card is completed at terminal 40.

Examination order management database 100d is referred by server device 10 when an examination order of a patient is given by server device 10, and when server device 10 extracts patient list data for each department. If server device 10 gives an examination order, all data except for the complete flag is registered in examination order management database 100d. The complete flag is registered when terminal 40 notifies server device 10 that the health insurance card verification process is completed (in this example, “1” shows that the health insurance card verification process is completed). In this example, examination order management database 100d includes data relating to patients who will visit the hospital on the same day.

### 5. Example of Operations

### 5-1. Reception Process for a New Patient

FIG. 10 shows a flowchart illustrating the reception process for a new patient. A staff member at the reception process for a new patient receives a written application and health insurance card from a patient. In the written application, predetermined items, for example, name of the patient, a department in which the patient whishes to receive a medical service, are described. The staff member inputs patient data into terminal 20 in accordance with the written application, and inserts the health insurance card into terminal 20.

Control unit 201 of terminal 20 controls display unit 204 to display an image prompting a user to input the patient data. Control unit 201 receives an input of the patient data from input unit 203 (in step S201). Control unit 201 controls read unit 202 to read the health insurance card data from the health insurance card (in step S202). Read unit 202 sequentially reads the health insurance cards at a predetermined reading position. Read unit 202 compares the read image with reference images, each of which is determined according to a type of the health insurance card. Read unit 202 identifies a type of the read health insurance card. Read unit 202 identifies an area on which personal information relating to items determined in response to the type of the health insurance card is provided. Read unit 202 converts the image of the identified area into text data. Read unit 202 outputs health insurance card data to control unit 201. The health insurance card data includes the health insurance card text data and the read health insurance card image data. The health insurance card text data includes the converted text data and information relating to the items.

Control unit 201 transmits a data set including the read health insurance card data and the patient data received in step S201, via communication unit 207 to server device 10 (in step S203).

When control unit 101 of server device 10 receives, via communication unit 103, the patient data and the health insurance card data that are transmitted from terminal 20 (in step S301), control unit 101 adds a patient ID to the received patient data, and registers the patient data with the patient ID in patient database 100a. Further, control unit 101 registers the received health insurance card data with the patient ID into health insurance card database 100b in storage unit 102 and stores a timestamp showing the time and date on which the patient data are received (in step S302).

Control unit 101 reads examination order management database 100d from storage unit 102. Control unit 101 identifies an examination order to be given for the next patient, based on the identification of the department included in the patient data and examination order management database 100d (in step S303). The date stored in RAM is used as the reception date. For each department, control unit 101 adds a sequential number in an order of reception date.

Control unit 101 registers in examination order management database 100d the patient ID, the name of the patient, the examination order, and the reception date (in step S304). The patient ID and the name of patient are included in the patient data. The examination order is identified in step S303. Control unit 101 transmits to terminal 20 via communication unit 103 a data set including the patient ID of the patient, the name of the patient, and the examination order (in step S305).

Control unit 201 of terminal 20 receives the patient ID of the patient, the name of the patient, and the examination order from server device 10 via communication unit 207 (in step S204). Control unit 201 issues a patient identification card in which the obtained patient ID and the name of the patient are recorded, by patient identification card issue unit 205. Further, control unit 201 issues a reception sheet that describes the obtained patient ID, the name of the patient, and the examination order (in step S205).

### 5-2. Reception Process for a Revisiting Patient

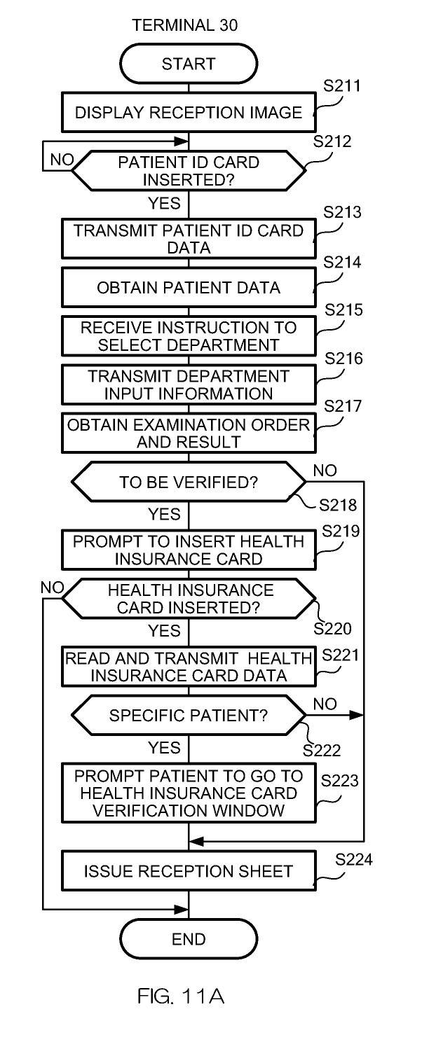

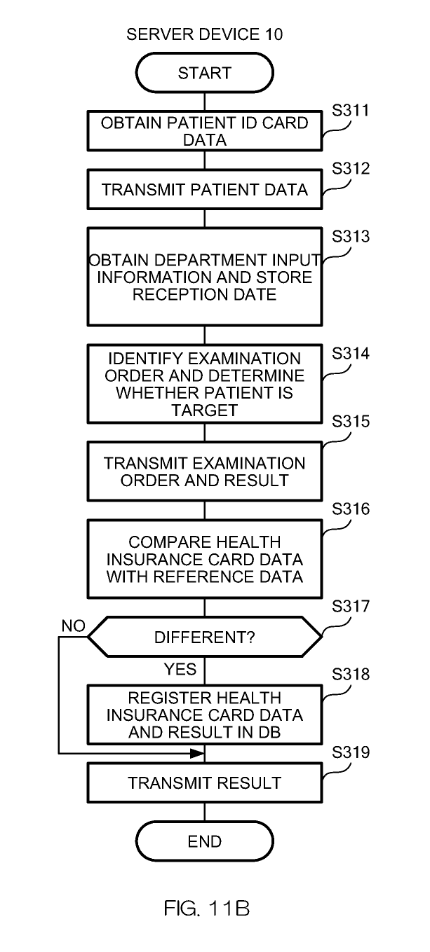

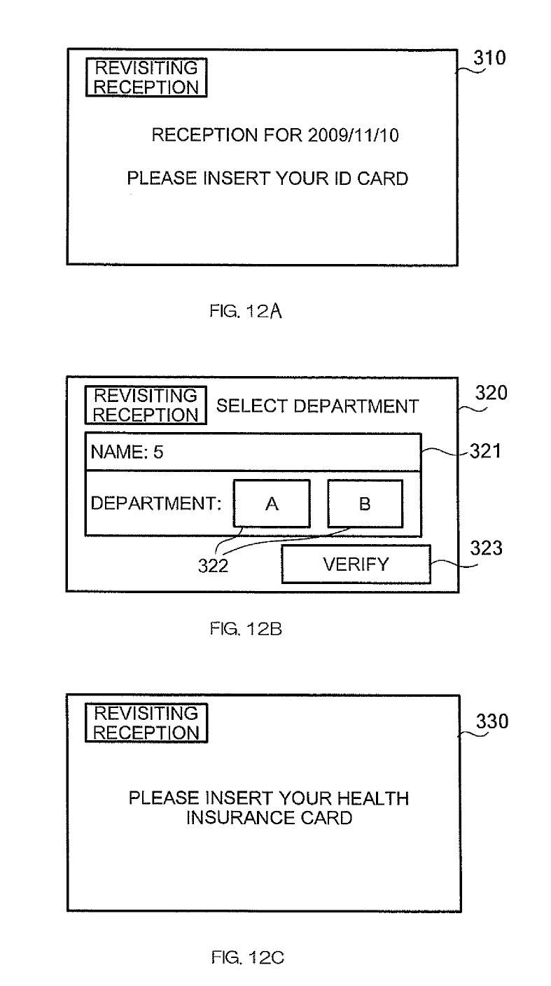

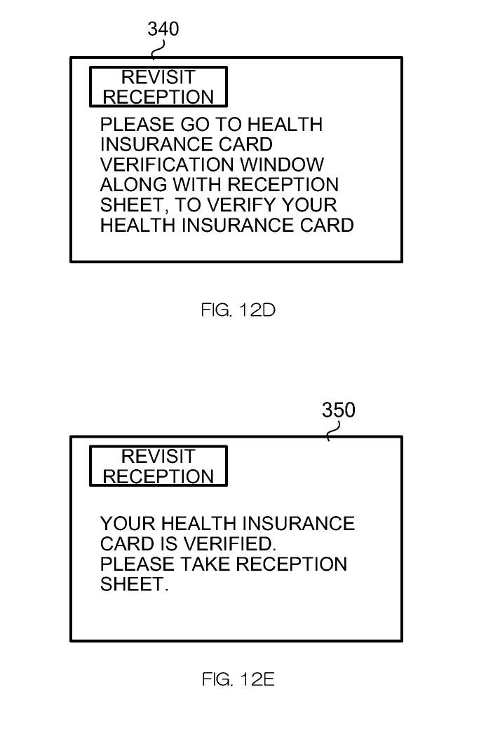

FIGS. 11A and 11B show flowcharts illustrating a reception process for a revisiting patient executed on terminal 30 and server device 10. A revisiting patient operates terminal 30 relating to the reception process for a revisiting patient. In FIG. 11A, display unit 303 of terminal 30 displays reception image 310 as shown in FIG. 12A, which shows a message for a revisiting patient, under the control of control unit 301 (in step S211). The patient inserts a patient identification card into a patient identification card slot (not shown in the figures) in terminal 30.

When the patient identification card is inserted (S212: YES), control unit 301 of terminal 30 controls read unit 302 to read the patient identification card data including the patient ID and the name of the patient. Control unit 301 transmits the read patient identification card data to server device 10 via communication unit 306 (in step S213).

In FIG. 11B, control unit 101 of server device 10 receives the patient identification card data from terminal 30 via communication unit 103 (in step S311). Control unit 101 reads the patient data corresponding to the patient ID in the patient identification card data from patient database 100a in storage unit 102, and transmits the patient data to terminal 30.

In FIG. 11A, control unit 301 of terminal 30 obtains the patient data from server device 10 (in step S214). Control unit 301 receives the patient data and controls display unit 303 to display menu image 320, which prompts a patient to select a department, as shown in FIG. 12B. Control unit 301 receives an instruction by a patient to select a department (in step S215).

As shown in FIG. 12B, menu image 320 includes patient name 321 included in the patient data obtained from server device 10, button 322 to select a department, and button 323 to verify the health insurance card. The patient selects a department by touching a button on which is shown an identification of a department at which the patient wishes to receive a medical service, and completes the selection of the department by touching button 323.

Referring to FIG. 11A again, control unit 301 of terminal 30 transmits to server device 10 department input information including information showing a department selected by the patient in step S215, and the patient ID of the patient (in step S216).

Referring to FIG. 11B again, control unit 101 of server device 10 obtains the department input information from terminal 30. Control unit 101 stores in the RAM the department input information and the date on which control unit 101 obtains the department input information (in step S313). Control unit 101 identifies as the examination number of the patient a number subsequent to the that shown in the examination order allocated to the last reception date and time before the date and time stored in the RAM.

Control unit 101 determines whether the patient is a target patient, based on the last verification date and the revisit reception date in health insurance card database 100b stored in storage unit 102 (in step S314). The target patient is a patient whose health insurance card is to be verified. There is considered an example where the last verification date of a patient who completes the reception process for a revisiting patient is Sep. 15, 2009, and the revisit reception date at terminal 30 is Nov. 10, 2009. In this case, since the revisit reception date is not in the same month as the last verification date, it is determined that the health insurance card of the patient is to be verified. Control unit 101 transmits to terminal 30 the patient ID, the examination order determined in step S314, and the results of the determination made in step S315.

In FIG. 11A, control unit 301 of terminal 30 obtains from server device 10 the patient ID, the examination order, and the results of determination whether the patient is a patient whose health insurance card is to be verified (in step S217). Control unit 301 stores the data in the RAM. If the obtained results show that the patient is a patient whose health insurance card is to be verified (step S218: YES), control unit 301 controls display unit 303 to display an image 330 prompting the patient to insert the health insurance card (in step S219).

If a health insurance card is inserted into the health insurance card slot (not shown in the figures) of terminal 30 (step S220: YES), control unit 301 controls read unit 304 to read the health insurance card. Control unit 301 transmits to server device 10 the health insurance card data along with the patient ID stored in the RAM (in step S221). The health insurance card data includes the health insurance card text data and the health insurance card image data. The health insurance card text data includes text data of items included in the health insurance card. In other words, control unit 301 transmits as the health insurance card text data the name of the patient, the insurer's number, and the birth date, along with the health insurance card image data and the patient ID.

In FIG. 11B, control unit 101 of server device 10 obtains the patient ID and the health insurance card data from terminal 30. Control unit 101 compares the health insurance card text data in the obtained health insurance card data with the health insurance card text data relating to the patient ID in health insurance card database 100b stored in storage unit 102, for each item (in step S316), and identifies a part(s) at which they are different from each other (in step S317).

If there is a part at which the health insurance card text data in the obtained health insurance card data and the health insurance card text data relating to the patient ID in health insurance card database 100b stored in storage unit 102 are found to be different from each other in step S317 (step S317: YES), control unit 101 registers in unverified card database 100c the compared health insurance card data along with the patient ID. In other words, control unit 101 registers in unverified card database 100c the health insurance card image data read by terminal 30 and the health insurance card text data along with the patient ID. The health insurance card text data includes difference information indicating an item of compared data whose content is different. Further, control unit 101 stores a flag “1” indicating that a difference is found as a result of the comparison, as a verification result of the patient ID in health insurance card database 100b (in step S318). Control unit 101 transmits the verification results to terminal 30 (in step S319).

In FIG. 11A, control unit 301 of terminal 30 obtains the verification results relating to the health insurance card from server device 10. If the verification results show that a difference is found (step S222: YES), control unit 301 determines that the patient is a specific patient. In this case, control unit 301 controls display unit 303 to display image 340 (shown in FIG. 12D) that shows that the reception process for a revisiting patient is completed, so as to prompt the patient to proceed with the health insurance card verification process at the health insurance card verification window (in step S223). Control unit 301 controls reception sheet issue unit 305 to issue a reception sheet on which the patient ID, the name of the patient, and the identification of the department are printed and the examination order is not printed (in step S224).

If the obtained results show that the patient is not a patient whose health insurance card is to be verified (step S218: NO), control unit 301 controls display unit 303 to display image 350 shown in FIG. 12E. Control unit 301 controls reception sheet issue unit 305 to issue a reception sheet on which the patient ID, the name of the patient, the identification of the department, and the examination order are printed (in step S224).

If the patient identification card is not inserted (step S212: NO), control unit 301 waits until the patient identification card is inserted with reception image 310 being displayed. Further, if the health insurance card in not inserted into the health insurance card slot (not shown in the figures) within a predetermined time period (step S220: NO), control unit 301 terminates the reception process for a revisiting patient. In such a case, an image that prompts the patient to report to another window such as the health insurance card verification window, may be displayed on display unit 303 similarly to step S222. Further, if the verification results show that no difference is found (step S222: NO), control unit 301 causes the operation to proceed to step S224.

### 5-3. Health Insurance Card Verification Process

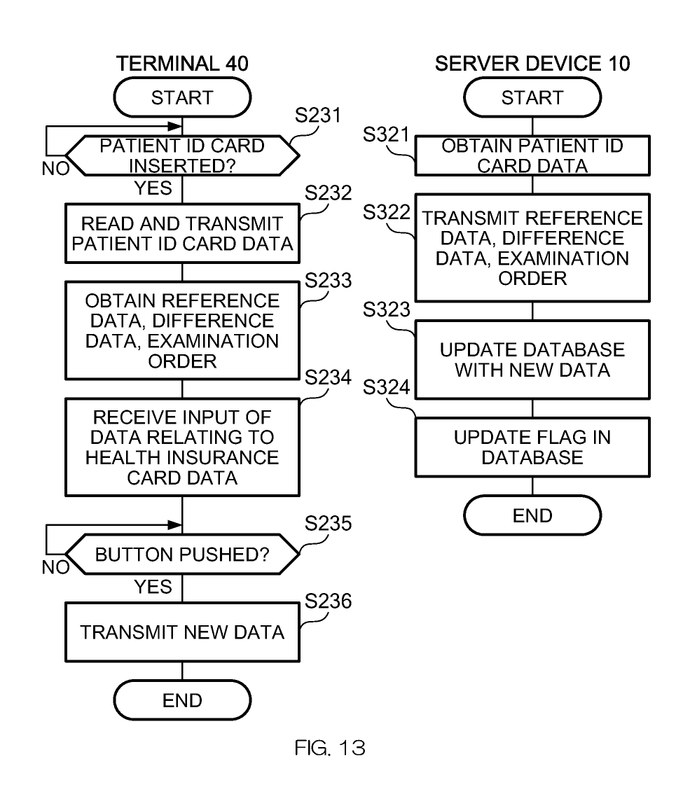

FIG. 13 shows a flowchart illustrating the health insurance card verification process in terminal 40. In the following example, an image showing a menu for the health insurance card verification process is displayed on display unit 403.

The specific client who is prompted to go to the health insurance card verification window, submits the patient identification card and the health insurance card to a staff member at the health insurance card verification window, so as to verify health insurance card. The staff member at the health insurance card verification window inserts the patient identification card into the patient identification card slot (not shown in the figures) at read unit 402 in terminal 40. If the patient identification card is inserted into read unit 402 (step S231: YES), control unit 401 controls read unit 402 to read the patient identification card, and transmits the read patient identification card data to server device 10 via communication unit 405 (in step S232).

Control unit 101 of server device 10 obtains the patient identification card data of the specific patient from terminal 40 via communication unit 103 (in step S321). Control unit 101 reads the health insurance card text data from health insurance card database 100b in storage unit 102 to compare it to the patient ID included in the obtained patient identification card data. Control unit 101 confirms that the verification results show there is a difference in the health insurance card data. Control unit 101 reads the health insurance card text data of the patient ID from unverified card database 100c in storage unit 102. Further, control unit 101 reads the examination order corresponding to the patient ID from examination order management database 100d. Control unit 101 transmits the health insurance card text data for the comparison and the health insurance card text data including a difference, to terminal 40 (in step S322).

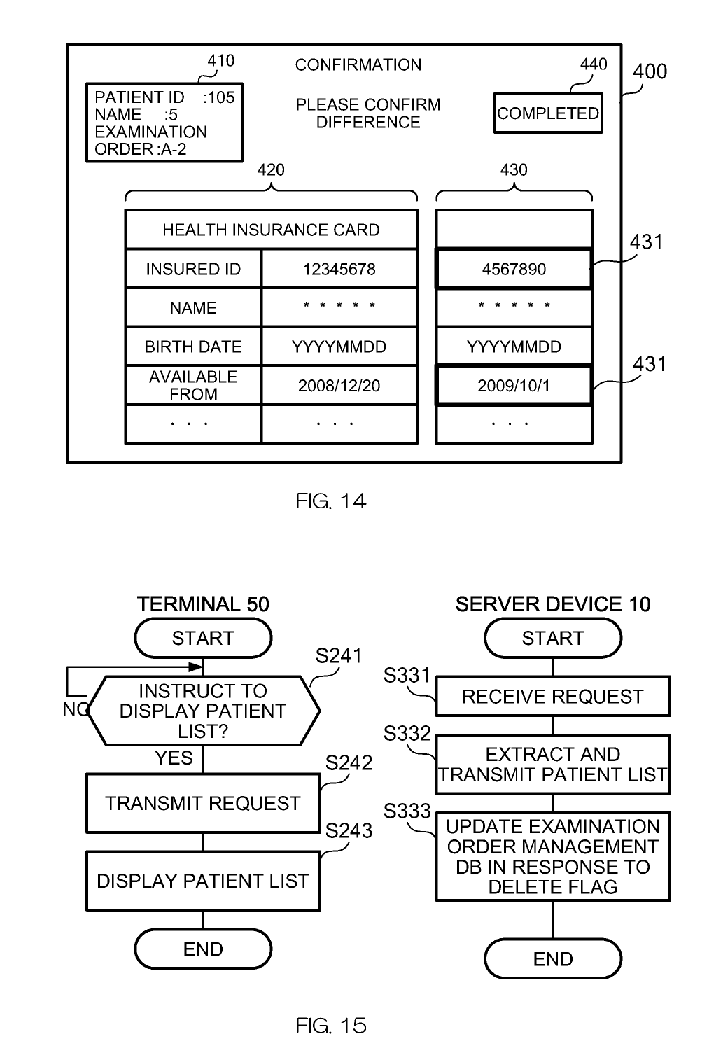

Control unit 401 of terminal 40 obtains from server device 10 the health insurance card text data for the comparison and the health insurance card text data including a difference, relating to the specific patient (in step S233). Control unit 401 controls display unit 403 to display image 400 shown in FIG. 14 for the health insurance card verification process.

Here, an explanation will be given regarding image 400 shown in FIG. 14. Image 400 shows a menu for a procedure. Image 410 shows the patient ID and the name of the patient based on the patient identification card data and the examination order obtained from server device 10. Image 420 shows items of information contained in the health insurance card (insured person's number, name, birth date, for example) that are used for the comparison and obtained from server device 10. Image 430 shows items of the health insurance card text data that are different from the items shown in image 420. Image 440 shows a button to receive an instruction to quit the menu.

The health insurance card text data obtained from server device 10 includes difference information showing a difference(s) from the health insurance card text data for the comparison. In this example, items different from the health insurance card text data for the comparison are shown by bold line 431, so that a staff member can recognize the difference. It is to be noted that the difference may be shown in another style, for example, by a different color.

Referring to FIG. 13 again. The staff member verifies the item shown on display unit 403 by bold line 430, referring to the health insurance card received from the specific patient. If necessary, the staff member inputs data relating to the different items, by operating input unit 404. Control unit 401 receives the input data and overwrites the data with the input data (in step S234).

If the staff member completes the verification process for the health insurance card, the staff member pushes button 440 in image 400. When control unit 401 receives an instruction as a result of button 440 having been pushed (step S235: YES), control unit 401 transmits the updated health insurance card text data to server device 10 (in step S236).

It is to be noted that when completing the verification of the health insurance card, the staff member receives the reception sheet from the specific patient. Further, the staff member writes the examination order onto the reception sheet. The examination order is shown in image 400. In other words, the examination order is given during the process of revisiting reception. The staff member returns the reception sheet to the specific patient. The specific patient thus can know the examination order that could not be known when the reception sheet was issued from terminal 30.

Control unit 101 of server device 10 obtains from terminal 40 the new health insurance card text data of the specific patient. Control unit 101 updates the health insurance card text data in health insurance card database 100 with the new health insurance card text data. Further, control unit 101 updates the health insurance card image data in health insurance card database 100 with the health insurance card image data stored in unverified card database 100c (in step S323).

When control unit 101 obtains from terminal 40 the new health insurance card text data of the specific client, control unit 101 writes “1” as the complete flag of the specific patient in examination order management database 100d (in step S324).

Control unit 401 of terminal 40 waits for the patient identification card being inserted into read unit 402 (step S231: NO). Control unit 401 of terminal 40 waits for button 440 being pushed by the staff, with image 400 being displayed on display unit 403.

### 5-4. Displaying Patient List

FIG. 15 shows a flowchart illustrating displaying the patient list in terminal 50a at department A. In the following example, a menu for displaying the patient list is displayed on display unit 503. It is to be noted that although a description will be given only for terminal 50a, terminal 50b also operates similarly to terminal 50a.

If control unit 501 of terminal 50a receives via input unit 503 an instruction by a doctor to display a patient list (step S241: YES), control unit 501 transmits a request for transmitting the patient list of the department A (in step S242). If control unit 501 does not receive an instruction by a doctor to display the patient list (step S241: NO), control unit 501 waits for the instruction, with a menu being displayed on display unit 503.

Control unit 101 of server device 10 receives the request from terminal 50a (in step S331). Control unit 101 extracts a data set including an identification of the department A from examination order management database 100d in storage unit 102. Control unit 101 transmits the extracted data set to terminal 50a via communication unit 103, as the patient list of the department A (in step S332). In the example of examination order management database 100d shown in FIG. 9B, data sets including the patient ID 101, and 103 to 105m are extracted.

It is to be noted that since new patients and revisiting patients are continually received, the examination order management database 100d are continually updated. After server device 10 transmits the patient list to each terminal 50, server device 10 periodically transmits the updated patient list to each terminal 50.

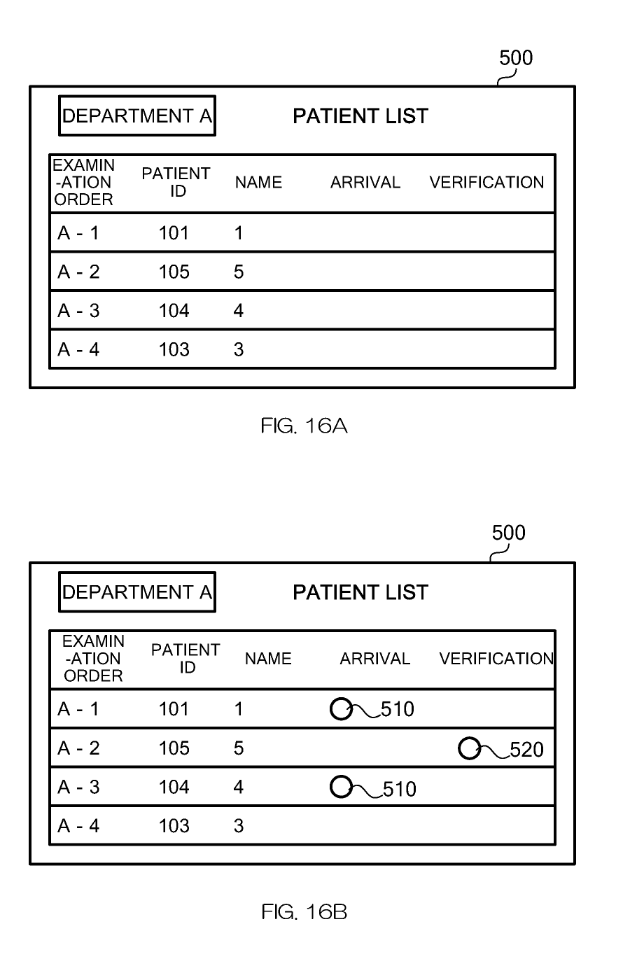

Control unit 501 of terminal 50a receives the patient list of the department A from server device 10 via the communication unit 504. Control unit 501 controls display unit 502 to display image 500 shown in FIG. 16A, based on the received patient list. Image 500 shows the patient list (in step S243).

As shown in FIG. 16A, in image 500, data sets are shown in the examination order. Each of the data sets includes the examination order in the department A, the patient ID, the name of the patient, arrival information showing whether the patient has arrived at the reception of the department A, and health insurance card window information showing whether the verification process at the health insurance card verification window is completed. A doctor who is going to call a patient according to the examination order refers to image 500 to confirm the schedule of examination.

Control unit 501 continually updates image 500 based on the updated patient list. Further, control unit 501 continually updates the arrival information and the health insurance card information, based on the updated patient list. Description will be given for display control in step S243.

### 5-4-1. Display Control

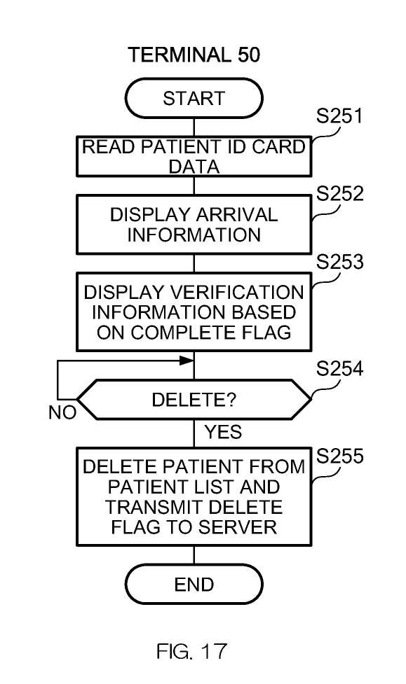

FIG. 17 shows a flowchart illustrating display control in terminal 50. A new or revisiting patient inserts his/her own patient identification card into the patient identification card slot of reader 500 that is positioned at the reception of the department A, so as to notify the doctor that the patient has arrived at the department A.

Control unit 501 of terminal 50a reads the patient identification card data from the patient identification card inserted into reader 500 (in step S251). Control unit 501 controls displaying the arrival information based on the patient identification card data read by reader 500 (in step S252). More specifically, control unit 501 controls display unit 502 to display circle 510 indicating the arrival information corresponding to the patient ID included in the patient identification card data read by reader 500, as shown in FIG. 16B. Further, control unit 501 controls display unit 502 to display circle 520 indicating the health insurance card window information corresponding to the patient ID whose complete flag is “1,” by referring to the complete flag in the patient list (in step S253). The process is executed in parallel with the process in step S252.

In this example, the arrival information and the health insurance card window information are shown by circles 510 and 520. However, the arrival information and the health insurance card window information may be shown by other kind of image.

A doctor of the department A calls and examines the patient in accordance with the examination order shown in the displayed patient list. If the doctor completes examination of a patient, the doctor inputs an instruction via input unit 503 to delete the patient from the patient list. If control unit 501 receives an instruction to delete a patient from the patient list (step S254: YES), control unit 501 controls display unit 502 to delete a data set of the patient from the patient list. Further, control unit 501 transmits a delete flag indicating that the data set relating to the patient is deleted from the patient list (in step S255).

If control unit 501 does not receive an instruction to delete a patient from the patient list (step S254: NO), control unit 501 waits for the instruction, with the patient list being displayed.

Referring to FIG. 15 again. If control unit 101 of server device 10 receives the delete flag from terminal 50a, control unit 101 updates examination order management database 100d by deleting a data set indicated by the delete flag (in step S333).

The doctor of the department A confirms whether the patient to whom the next examination order is allocated has arrived at the reception of the department A. Further, the doctor confirms whether the patient has completed verification at the health insurance card verification window by referring to the health insurance card verification window information in the patient list. For example, if the patient having the next examination order has not arrived at the reception of the department A and circle 520 is displayed corresponding to the patient, the doctor may select to call the next patient or to wait, taking into consideration time required to arrive at the reception from the health insurance card verification window. It is to be noted that, regardless of whether the patient is required to go to the health insurance card verification window or not, if the next patient has been called before the patient, the patient may be given priority after arriving at the reception.

In health insurance card verification system 1, a patient can operate terminal 30 to proceed with the verification process of the health insurance card. Therefore, it is not necessary for a staff member to verify the health insurance card of the specific patient. The staff member verifies at the health insurance card verification window the health insurance card for a patient whose health insurance card has not been verified at terminal 30.

At terminal 40, differences between the reference data and the health insurance card text data are shown visually, whereby the staff member can easily recognize the differences and update the data. Further, the staff member can notify the patient of his/her examination order by writing the examination order on the reception sheet of the patient.

At each department, the patient list is displayed on terminal 50. A doctor at each department can easily confirm whether the next patient has arrived at the department. Further, the doctor can easily confirm that the patient has completed the verification process at the health insurance card verification window. Therefore, when the patient arrives at the department, the doctor can call the patient prior to another patient if the patient has the earliest examination order. Therefore, a patient who went to the health insurance card verification window for the health insurance card verification process can receive a medical service promptly after arriving at the department.

### 6. Modification

The present embodiment is not restricted to the embodiment described above. The invention may include the following modifications.

### 6-1. Modification 1

In the embodiment, the comparison process for the health insurance card data of the specific patient is executed on server device 10. However, terminal 30 may execute the comparison process. In this case, terminal 30 obtains the health insurance card text data (reference data) of the specific patient, and compares the obtained health insurance card text data with the health insurance card text data read at terminal 30. Further, terminal 30 prompts a user to go to the health insurance card verification window to complete the health insurance card verification process and issues a reception sheet, in response to the verification results. Further, terminal 30 transmits the read health insurance card data (including difference information) and the verification results showing that there is a difference, to server device 10. Server device 10 obtains from terminal 30 the health insurance card data for which the verification results show that there is a difference. Server device 10 stores the obtained health insurance card data in unverified card database 100c.

### 6-2. Modification 2

In the embodiment, the health insurance card data read by terminal 30 is transmitted to server device 10 and stored in storage unit 102. However, the health insurance card data may not be transmitted to server device 10. In this case, server device 10 only stores the verification results and the difference information relating to the health insurance card data read by terminal 30. Further, terminal 40 has a reading unit that has a similar function to that of read unit 202 in terminal 30 so as to read the health insurance card data of the specific patient. Terminal 40 obtains the difference information relating to the health insurance card corresponding to the specific patient. Terminal 40 identifies a different part in the read health insurance card data, with reference to the difference information. Terminal 40 displays image 400 so as to visually identify the different part.

### 6-3. Modification 3

The modification 1 may be modified so that terminal 30 transmits to server device 10 the verification results and does not transmit the health insurance card data (including difference information). In such a case, similarly to modification 2, terminal 40 reads health insurance card data and executes the comparison process for the health insurance card data. When terminal 40 reads the health insurance card data of the specific patient, terminal 40 obtains from server device 10 the health insurance card text data (including reference data) of the specific patient. Control unit 401 compares the obtained reference data and the read health insurance card text data. Control unit 401 displays image 400 so as to enable visual identification of the different part. Terminal 40 replaces the read health insurance card text data with the data input by a staff member at the health insurance card verification window. When completing the health insurance card verification process, terminal 40 transmits the updated health insurance card text data and the read health insurance card image data to server device 10, as the updated health insurance card data. Control unit 101 of server device 10 replaces the health insurance card data of the specific patient in health insurance card database 100b with the health insurance card data of the specific patient transmitted from terminal 40, similarly to the embodiment described above. Therefore, in the present modification, server device 10 does not store unverified card database 100c.

### 6-4. Modification 4

Patient database 100a may include an expected date of the next examination for each patient, as reservation information. In such a case, for example, the doctor inputs the expected date of the next examination as reservation information. Terminal 50 transmits to server device 10 the input reservation information together with the patient ID. Server device 10 obtains the reservation information from terminal 50. Server device 10 stores the reservation information in a patient data set including the patient ID identical with the patient ID included in the reservation information, in patient database 100a.

If a patient data set received from server device 10 includes the reservation information, terminal 30 displays on display unit 303 an image showing the expected date of the next examination and the department to be visited, instead of image 320, to select a department. If the patient inputs an instruction to complete the confirmation of the expected date of the next examination, terminal 30 transmits to server device 10 the examination order of the patient. Terminal 30 obtains the examination order of the patient from server device 10. It is to be noted that when the examination order is given for a patient for whom the reservation information is stored, the examination order for the patient with the reservation is given priority over that of a patient not having a reservation, regarding an examination time per patient.

### 6-5. Modification 5

In the embodiment, the system has one server device 10. However, the system may have plural server devices corresponding to sets of processes, instead of the server device 10. These server devices may transmit and receive data to and from each other.

### 6-6. Modification 6

In the embodiment, a staff member inputs the patient data, referring to the application written by the patient during the reception process for a new patient. However, terminal 20 may have an OCR device that reads data written on the written application and may register the read text data into patient database 100a, as the patient data. Further, terminal 20 may compare the text data of the written application with the health insurance card data for predetermined items, for example, the name and the birth date of the patient. In such a case, if the contents of the items are coincident with each other, terminal 20 transmits to server device 10 the text data of the written application and the health insurance card data along with the patient ID obtained from server device 10. Further, terminal 20 may display the text data of the written application, the health insurance card data, and the verification results. The text data of the written application and the health insurance card data are compared for each patient. The staff member may compare the text data of the written application and the health insurance card data. Terminal 20 may receive an input of data of the written application and the health insurance card. Terminal 20 transmits to server device 10 the text data of the written application after the comparison, as the patient data, along with the health insurance card data and the patient ID. It is to be noted that terminal 20 may display the data of the written application and the health insurance card with a visually identified difference.

### 6-7. Modification 7

In the embodiment, when the reception sheet is issued, the examination order is not printed on the reception sheet in response to the verification results. However, when the reception sheet is issued, the examination order may be printed thereon.

### 6-8. Modification 8

In the embodiment, the health insurance card window information, which indicates that the health insurance card verification process has been completed, is shown in the patient list visually. However, progress information, which indicates that the health insurance card verification process for the specific patient is being executed at terminal 40, may be shown in the patient list. In this case, terminal 40 transmits to server device 10 the patient ID of the specific patient and the progress information when terminal 40 receives an instruction to display image 400 for prompting the specific patient of the health insurance card verification process. When server device 10 obtains the patient ID of the specific patient, server device 10 transmits to terminal 50 a data set for the patient list including the patient ID of the specific patient, along with the progress information. If a data set for the patient list transmitted from server device 10 includes the progress information, terminal 50 displays a patient list including the progress information. The doctor of the department thus can confirm the status of the specific patient.

### 6-9. Modification 9

In the embodiment, terminal 30 reads the health insurance card data of the specific client, and server device 10 compares the data. However, terminal 30 may read the health insurance card data of every client, and server device 10 may compare the data. In this case, terminal 30 transmits to server device 10 the read health insurance card data for every client. Server device 10 determines whether a patient is a specific patient by comparing his/her health insurance card data with the reference data. If the patient is a specific client, server device 10 updates health insurance card database 100b and unverified card database 100c based on the verification results of the patient. If the health insurance card text data of the specific patient is coincident with the reference data, server device 10 updates the last verification date and the verification results in health insurance card database 100b. If the health insurance card text data of the specific patient is different from the reference data, server device 10 adds the health insurance card data of the specific patient to unverified card database 100c and updates the verification results in health insurance card database 100b. Further, server device 10 notifies terminal 30 that the patient is the specific client. If terminal 30 is notified that the patient is a specific patient, terminal 30 prompts the patient to verify the health insurance card at the health insurance card verification window by displaying image 340 as described above.

### 6-10. Modification 10

In the embodiment, for a new patient who visits the hospital for the first time, the reception process for a new patient is executed and health insurance card data are generated. However, for a new patient who is introduced from another hospital (second hospital), the health insurance card data may be received from the second hospital. Description will be given for this process. In each hospital, a new patient is requested to complete the patient information on a written application. The patient information is input to a reception device. Further, the health insurance card is verified. In the related art, if a patient is introduced from hospital h1 and hospital H, a similar procedure for the patient is required in hospitals h1 and H. According to the modification, the patient receives a medical service smoothly, since a workload of the patient in hospital H and a workload of the staff in hospital h1 are reduced.

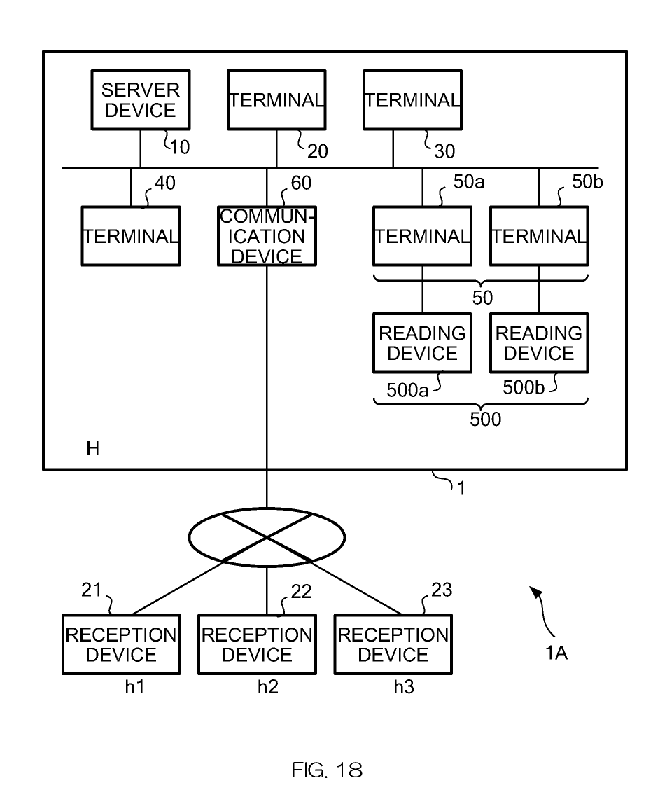

FIG. 18 shows an example of a configuration of health insurance card verification system IA according to the present modification. In hospital H, communication device 60 that communicates with another medical institute, as well as health insurance card verification system 1, is installed. Further, in each of hospitals h1, h2, and h3, reception devices 21, 22, and 23, as well as terminal 20, is installed. Each of reception devices 21, 22, and 23 has a communication unit to communicate with communication device 60. Communication device in hospital H and reception devices 21, 22, and 23 are connected via a communication network, a dedicated line, or the Internet, for example. Communication device in hospital H and reception devices 21, 22, and 23 communicate by using a predetermined address. It is to be noted that in this example, each of reception devices 21, 22, and 23 transmits a request for connection to communication device 60 in hospital H. Communication device 60 establishes a communication connection with the reception device, in response to the request.

Reception devices 21, 22, and 23 store the input patient data (name, birth date, sex, for example) based on the written application. Further, reception devices 21, 22, and 23 store the read health insurance card data along with the patient data.

If a patient is introduced from each of hospitals h1, h2, and h3 to hospital H, each of reception devices 21, 22, and 23 transmits the patient data along with introduced patient information to communication device 60. The introduced patient information includes health insurance card data corresponding to the patient data. It is to be noted that the above information includes items of information predefined in the patient database in hospital H.

Server device 10 in hospital H receives the introduced patient information from hospitals h1, h2, and h3 via communication device 60. Server device 10 adds a temporary patient ID to the introduced patient information. Server device 10 registers in the patient database in storage unit 102 a data set including the temporary patient ID and the patient data included in the introduced patient information. Further, server device 10 registers in health insurance card database 100b the health insurance card data included in the introduced patient information, as the health insurance card data corresponding to the temporary patient ID.

Server device 10 transmits the temporary patient ID to hospital h1, h2, or h3 that is a source of the introduction. The introduced patient receives the temporary patient ID in the source hospital. When the introduced patient arrives at hospital H, s/he submits the temporary patient ID at the reception of hospital H. A staff member of the new patient reception in hospital H reads the patient data relating to the temporary patient ID using terminal 20. Further, the staff member inputs data, for example, date of visit. Terminal 20 transmits to server device 10 the patient data of the temporary patient ID as a standard patient ID. Server device 10 replaces the patient data of the patient ID in patient database 100a with the patient data transmitted from terminal 20 so as to update patient database 100a.

If the expiration date of the verification process of the health insurance card has been reached before the introduced patient visits hospital H, the new reception in hospital H requests the patient to submit the health insurance card. A staff member visually compares the submitted health insurance card with the preregistered health insurance card data. If there is a difference, the staff member revises the data. The revised health insurance card data may be transmitted to reception device 21 of the source hospital h1, h2, or h3.

Since hospital H can receive the patient information along with the health insurance card data prior to the visit of the patient, workload for writing the written application or verifying the health insurance card can be reduced.

### 6-11 Modification 1

The health insurance card may not be restricted to the example described in the embodiment. The health insurance card may be any kind of document for certifying that the user can receive insurance. For example, the health insurance card may be a card on which social security number is described. Alternatively, the health insurance card may be a European health insurance card used in EU.

### 6-12 Modification 12

In the embodiment, patient ID and the name of the patient is stored in patient identification card. However, the name of the patient may not be stored in the patient identification card.

### 6-13 Modification 13

The health insurance card may be a magnetic or IC card that stores data showing the items of health insurance card. In such a case, the reading unit may be a magnetic card reader device or an IC card reader device.

1-6. (canceled)

7. A health insurance card verification system, comprising:
a first database;
a second database;
a first terminal that communicates with each of the first database and the second database;
a second terminal that communicates with each of the first database and the second database; and
a third terminal that communicates with each of the first database and the second database, wherein
the first terminal includes:
an ID obtaining unit configured to obtain a patient ID identifying a patient from a patient identification card;
an examination order obtaining unit configured to obtain an examination order corresponding to the patient ID obtained by the ID obtaining unit, from the first database;
a registration unit configured to register the examination order obtained by the examination order obtaining unit and the patient ID obtained by the ID obtaining unit;
a health insurance card data obtaining unit configured to obtain health insurance card data from a health insurance card of the patient;
a notification unit configured to notify that verification of the health insurance card is required, in a case that the health insurance card data obtained by the health insurance card data obtaining unit does not match reference data recorded in the second database, and
an issuing unit configured to issue a reception sheet on which the examination order of the patient obtained by the ID obtaining unit is printed if the health insurance card data read by the reading unit is coincident with the reference data, and on which the examination order of the patient is not printed if the health insurance card data read by the reading unit is not coincident with the reference data,
the second terminal includes:
an ID obtaining unit configured to obtain a patient ID identifying a patient from a patient identification card;
a display unit configured to display a different part of the health insurance card data relating to the patient ID obtained by the ID obtaining unit that is different from the health insurance card data in the second database as well as the examination order stored along with the patient ID in the first database;
a receiving unit configured to receive an input of data corresponding to the different part; and
an updating unit configured to update the second database by replacing a part of the reference data corresponding to the different part relating to the patient ID with the data received by the receiving unit, and
the third terminal includes:
a display unit configured to display a patient list including patient data obtained from the first database, in accordance with the examination order;
an ID obtaining unit configured to obtain the patient ID from the patient identification card; and a control unit configured to control the display unit to display the patient list in which the patient ID obtained by the ID obtaining unit is visually different from another patient ID.

8. The health insurance card verification system according to claim 7, wherein
the control unit in the third terminal controls display of the patient list so that the patient ID updated at the second terminal is visually different from non-updated patient ID.

9. The health insurance card verification system according to claim 7, further comprising
a fourth terminal including:
a first reading unit configured to read patient information relating to a patient from a written application;
a second reading unit configured to read health insurance card data from a health insurance card of the patient;
an obtaining unit configured to obtain a patient ID of the patient from a third database including patient data for each patient ID;
a registering unit configured to register the health insurance card data into the second database and the patient data corresponding to the patient ID into the third database if contents of items common to the patient information read by the first reading unit and the health insurance card data are coincident.

10. The health insurance card verification system according to claim 7, further comprising:
a processing device including:
a receiving unit configured to receive patient information including identification of a patient and the health insurance card data of the patient from another device;
a registering unit configured to register a data set in the second database, the data set including the patient ID, the patient information, and the health insurance card data, the patient ID being obtained from the first database.

11. A method for verifying a health insurance card in a system including a first terminal, a second terminal, and a third terminal, that can communicate with a first database and a second database, the method comprising:
obtaining, by the first terminal, a patient ID identifying a patient from a patient identification card;
obtaining, by the first terminal, an examination order corresponding to the obtained patient ID, from the first database;
registering, by the first terminal, the obtained examination order and the obtained patient ID;
obtaining, by the first terminal, health insurance card data from a health insurance card of the patient;
notifying, by the first terminal, that verification of the health insurance card is required, in a case that the obtained health insurance card data does not match reference data recorded in the second database;
issuing, by the first terminal, a reception sheet on which the obtained examination order is printed if the read health insurance card data is coincident with the reference data, and on which the examination order of the patient is not printed if the read health insurance card data is not coincident with the reference data,
obtaining, by the second terminal, a patient ID identifying a patient from a patient identification card;
displaying, by the second terminal, a different part of the health insurance card data relating to the obtained patient ID that is different from the health insurance card data in the second database as well as the examination order stored along with the patient ID in the first database;
receiving, by the second terminal, an input of data corresponding to the different part;
updating, by the second terminal, the second database by replacing a part of the reference data corresponding to the different part relating to the patient ID with the received data;
displaying, by the third terminal, a patient list including patient data obtained from the first database, in accordance with the examination order;
obtaining, by the third terminal, the patient ID from the patient identification card; and
controlling, by the third terminal, the display unit to display the patient list in which the patient ID obtained by the ID obtaining unit is visually different from another patient ID.
